(19) United States
(12) Patent Application Publication
(10) Pub. No.: US 2026/0235526 A1
(43) Pub. Date: Aug. 13, 2026

(54) Defect Inspection Device and Optical System

(71) Applicants: Hitachi High-Tech Corporation, Minato-ku, Tokyo (JP); Nikon Corporation, Minato-ku, Tokyo (JP)

(72) Inventors: Hiromichi YAMAKAWA, Tokyo (JP); Yuta URANO, Tokyo (JP); Toshifumi HONDA, Tokyo (JP); Eiji ARIMA, Tokyo (JP); Shunichi MATSUMOTO, Tokyo (JP); Jin NISHIKAWA, Tokyo (JP); Takashi TOMOZAWA, Tokyo (JP); Takahiro MASADA, Tokyo (JP)

(21) Appl. No.: 19/160,495

(22) PCT Filed: Jun. 15, 2023
(86) PCT No.: PCT/JP2023/022332

§ 371 Date: Aug. 28, 2025

(51) Int. Cl. G01N 21/88; G01N 21/95

(52) U.S. Cl. CPC G01N 21/8806; G01N 21/9501

(57) ABSTRACT

A defect inspection device includes an illumination unit that irradiates a sample with illumination light emitted from a light source; a detection unit that is disposed in an oblique direction with respect to the sample and detects scattered light generated from the sample; a pupil division mechanism that divides pupil of the detection unit into a first detection angle and a second detection angle; a first photoelectric conversion unit that converts scattered light at the first detection angle detected by the detection unit into an electrical signal; a second photoelectric conversion unit that converts scattered light at the second detection angle detected by the detection unit into an electrical signal; and a signal processing unit that processes the electrical signals converted by the first photoelectric conversion unit and the second photoelectric conversion unit to detect a defect in the sample, in which the pupil division mechanism divides the pupil such that pupil allocation corresponds to an inspection target or inspection conditions.

### TECHNICAL FIELD

The present invention relates to a defect inspection device and an optical system of a detection unit thereof. For example, the present invention relates to a defect inspection device that inspects minute defects present on a sample surface, and determines and outputs the position, type and size of the defect, and an optical system of the detection unit thereof.

### BACKGROUND ART

In manufacturing lines for semiconductor substrates, thin film substrates, etc., inspection of defects present on the surfaces of the semiconductor substrates, the thin film substrates, etc. is performed to maintain and improve product yield. As a related art of a defect inspection technology, for example, JP2014-504370A (PTL 1) is known.

PTL 1 describes a configuration “configured to divide the condensing numerical aperture (NA) of a condensing subsystem into different segments and to direct the scattered light collected in the different segments to separate detectors.” and as an example, for an aperture mirror disposed in the Fourier plane of the condensing subsystem, “the aperture mirror transmits scattered light collected in one segment of the condensing NA while reflecting scattered light collected in other segments of the condensing NA.” Further, a technology is disclosed in which “configured to separate scattered light in one of the different segments based on polarization to form a different portion of the scattered light” to reduce surface scattering from the wafer surface.

In PTL 2, a plurality of detection systems are arranged in a direction inclined to the sample surface to detect scattered light generated from minute defects, and defects are determined by forming an image of a linear illumination applied to the sample surface by each detection system at a sensor position. When the optical system is disposed to detect the image of the linear illumination from an oblique angle, the working distance between the detection unit and the linear illumination unit on the sample surface changes within the field of view. In this case, defocusing occurs, so the resolution of the image formed on the sensor surface is reduced. To prevent this, PTL 1 describes that the image on the substrate W to be inspected can be formed obliquely on the detector, by tilting the sensor to be conjugated with the substrate W to be inspected, depending on the inclination of the detection direction with respect to the substrate W to be inspected.

### CITATION LIST

### Patent Literature

PTL 1: JP2014-504370A
PTL 2: JP2007-033433A

### SUMMARY OF INVENTION

### Technical Problem

Defect inspection used in the manufacturing process of semiconductors, etc. requires the detection of minute defects, the measurement of the dimensions of the detected defects with high accuracy, the inspection of the sample non-destructively (e.g., without altering the sample), the obtaining of substantially consistent inspection results, for example, in terms of the number, position, dimensions, and type of defects detected, when inspecting the same sample, and the inspection of a large number of samples within a certain period of time.

In the technology described in PTL 1, in order to implement inspection of minute defects of 20 nm or less, an “aperture mirror” provided on the Fourier plane of the objective lens for discrimination from background scattered light is used to branch the optical path, and for each branched optical path, the optical path is further branched according to the polarization.

In an inspection method that branches the optical path, the directions in which scattered light from a defect and background scattered light propagate differ depending on the condition of the surface of the sample being inspected, so that the optical path branching conditions that provide the highest sensitivity differ. Furthermore, the optical path branching conditions that provide the highest sensitivity also differ depending on inspection conditions such as the incident direction of the illumination.

An object of the present invention is to provide a defect inspection device that can achieve optimal optical path branching conditions depending on an inspection target or inspection conditions.

### Solution to Problem

In order to solve the above problem, for example, the configuration described in the claims is adopted. Provided is a defect inspection device including: an illumination unit that irradiates a sample with illumination light emitted from a light source; a detection unit that is disposed in an oblique direction with respect to the sample and detects scattered light generated from the sample; a pupil division mechanism that divides pupil of the detection unit into a first detection angle and a second detection angle; a first photoelectric conversion unit that converts scattered light at the first detection angle detected by the detection unit into an electrical signal; a second photoelectric conversion unit that converts scattered light at the second detection angle detected by the detection unit into an electrical signal; and a signal processing unit that processes the electrical signals converted by the first photoelectric conversion unit and the second photoelectric conversion unit to detect a defect in the sample, in which the pupil division mechanism divides the pupil such that pupil allocation corresponds to an inspection target or inspection conditions.

### Advantageous Effects of Invention

According to the present invention, the pupil of the detection unit is divided such that pupil allocation corresponds to an inspection target or inspection conditions, so that background scattered light is discriminated and light scattered from minute defects is detected with high sensitivity. Problems, configurations, and effects other than those described above will become apparent from the following description of an embodiment.

### BRIEF DESCRIPTION OF DRAWINGS

FIG. 1 is an overall schematic configuration diagram showing one embodiment of a defect inspection device.

FIG. 2 is a diagram showing a first example of an illumination intensity distribution shape realized by an illumination unit.

FIG. 3 is a diagram showing the first example of the illumination intensity distribution shape realized by the illumination unit.

FIG. 4 is a diagram showing a second example of the illumination intensity distribution shape realized by the illumination unit.

FIG. 5 is a diagram showing a third example of the illumination intensity distribution shape realized by the illumination unit.

FIG. 6 is a diagram showing the third example of the illumination intensity distribution shape realized by the illumination unit.

FIG. 7 is a diagram showing an example of an optical element provided in an illumination intensity distribution control unit.

FIG. 8 is a diagram showing an illumination distribution shape and a scanning direction on a sample surface.

FIG. 9 is a diagram showing a trajectory of an illumination spot by scanning.

FIG. 10 is a diagram showing the arrangement and detection direction of a detection unit as viewed from the side.

FIG. 11 is a diagram showing the arrangement and detection direction of the detection unit as viewed from above.

FIG. 12 is a diagram showing a first example of the configuration of the detection unit.

FIG. 13 is a diagram showing the arrangement of the illumination spot and a photoelectric conversion unit.

FIG. 14 is a diagram showing the arrangement of the illumination spot and the photoelectric conversion unit.

FIG. 15 is a diagram showing the arrangement of a sample and a detection unit.

FIG. 16 is a cross-sectional configuration diagram of an image sensor.

FIG. 17 is a diagram showing the incidence angle dependence of the absorptance of an anti-reflection film.

FIG. 18 is a diagram showing a first example of the pupil division angle dependence of the SN ratio of scattered light from a defect.

FIG. 19 is a diagram showing a second example of the pupil division angle dependence of the SN ratio of scattered light from a defect.

FIG. 20 is a diagram showing a first example of a knife edge that divides a pupil.

FIG. 21 is a diagram showing a configuration of the detection unit in the case of oblique incidence illumination.

FIG. 22 is a diagram showing a configuration of the detection unit in the case of perpendicular illumination.

FIG. 23 is a diagram showing a second example of a knife edge that divides a pupil.

FIG. 24 is a diagram showing a second example of a configuration of the detection unit as viewed from above.

FIG. 25 is a diagram showing the second example of the configuration of the detection unit as viewed from the side.

FIG. 26 is a diagram showing a third example of a configuration of the detection unit as viewed from above.

FIG. 27 is a diagram showing a configuration of the detection unit when polarization to be detected is changed.

FIG. 28 is a diagram showing a configuration of the detection unit when the polarization of illumination is changed.

FIG. 29 is a diagram showing a third example of the knife edge that divides a pupil.

FIG. 30 is a diagram showing a driving mechanism of the knife edge.

FIG. 31 is a diagram showing a fourth example of the configuration of the detection unit as viewed from the side.

### DESCRIPTION OF EMBODIMENTS

Below, the embodiments of the present invention will be described with reference to the drawings. Note that the present invention is not limited to the embodiments described below, and includes various modifications. The embodiments described below are described in detail to describe the present invention in an easy-to-understand manner, and are not necessarily limited to those having all of the configurations described. It is also possible to replace part of the configuration of one embodiment with another embodiment, and it is also possible to add other embodiments to the configuration of one embodiment. Furthermore, a part of the configuration of each embodiment can be added to, deleted from, or replaced with other configurations.

In the following embodiment, the present invention is described as being applied to a defect inspection device used for defect inspection performed in the manufacturing process of semiconductors or the like.

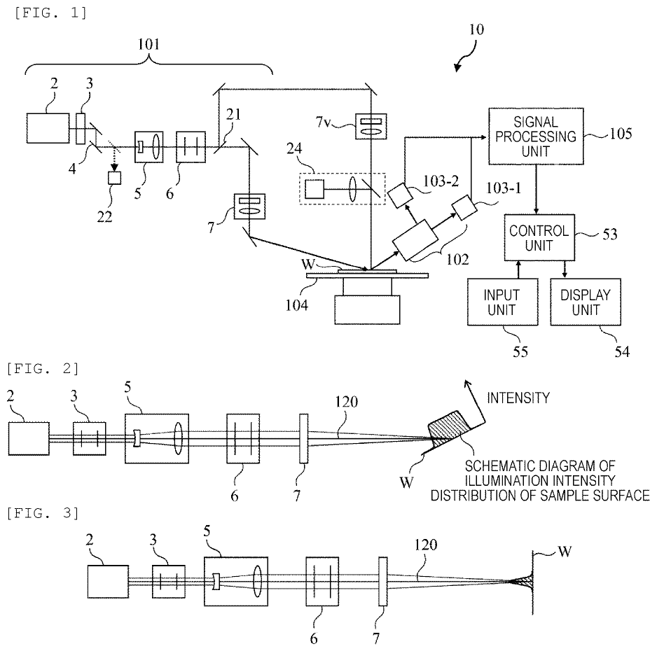

FIG. 1 is a schematic configuration diagram of this embodiment. A defect inspection device 10 includes, as its main parts, an illumination unit 101, a detection unit 102, photoelectric conversion units 103-1 and 103-2, a stage 104 on which a sample W can be placed and which can be moved in a direction perpendicular to the surface by an actuator, a signal processing unit 105, a control unit 53, a display unit 54, and an input unit 55.

The illumination unit 101 appropriately includes a laser light source 2, an attenuator 3, an emitted light adjustment unit 4, a beam expander 5, a polarization control unit 6, and an illumination intensity distribution control unit 7. The laser light beam emitted from the laser light source 2 is adjusted to a desired beam intensity by the attenuator 3, adjusted to a desired beam position and beam traveling direction by the emitted light adjustment unit 4, adjusted to a desired beam diameter by the beam expander 5, adjusted to a desired polarization state by the polarization control unit 6, and adjusted to a desired intensity distribution by the illumination intensity distribution control unit 7, and is applied onto the inspection target region of the sample W.

The incidence angle of the illumination light on the sample surface is determined by the position and angle of a reflecting mirror of the emitted light adjustment unit 4 arranged in the optical path of the illumination unit 101. The incidence angle of the illumination light is set to an angle suitable for detecting minute defects. The larger the illumination incidence angle, that is, the smaller the illumination elevation angle (angle between the sample surface and the illumination optical axis), the weaker the scattered light (called haze) from minute irregularities on the sample surface that becomes noise in the scattered light from minute foreign matters on the sample surface, making it more suitable for detecting minute defects. For this reason, when the scattered light from minute irregularities on the sample surface interferes with the detection of minute defects, the incidence angle of the illumination light is preferably set to 75 degrees or more (elevation angle of 15 degrees or less). On the other hand, in oblique incidence illumination, the smaller the illumination incidence angle, the greater the absolute amount of scattered light from minute foreign matters, so when a lack of scattered light from defects interferes with the detection of minute defects, the incidence angle of the illumination light may preferably be set to 60 degrees or more and 75 degrees or less (elevation angle of 15 degrees or more and 30 degrees or less). Furthermore, when performing oblique incidence illumination, the polarization control by the polarization control unit 6 of the illumination unit 101 allows the polarization of the illumination to be P-polarized, which increases the scattered light from defects on the sample surface compared to other polarizations. Furthermore, when scattered light from minute irregularities on the sample surface interferes with the detection of minute defects, the polarization of the illumination is set to S-polarized, which reduces the scattered light from minute irregularities on the sample surface compared to other polarizations.

If necessary, as shown in FIG. 1, a mirror 21 is inserted in the optical path of the illumination unit 101, and other mirrors are appropriately arranged, thereby changing the illumination optical path and irradiating the sample surface with illumination light from a direction substantially perpendicular to the sample surface (perpendicular illumination) In this case, the illumination intensity distribution on the sample surface is controlled by the illumination intensity distribution control unit 7v in the same manner as in oblique incidence illumination. By inserting a beam splitter in the same position as the mirror 21, oblique incidence illumination and perpendicular illumination can be performed simultaneously. To obtain scattered light from concave defects on the sample surface (polishing scratches or crystal defects in crystalline materials), perpendicular illumination, with incidence substantially perpendicular to the sample surface, is suitable.

To detect minute defects near the sample surface, as the laser source 2, a laser source that emits a ultraviolet or vacuum ultraviolet laser beam of a short-wavelength (wavelength 355 nm or less) that does not easily penetrate the inside of the sample and has a high output of 2 W or more is used. The diameter of the emitted beam is about 1 mm. To detect defects inside a sample, a laser source that emits a visible or infrared laser beam having a wavelength that easily penetrates the inside of the sample is used.

The attenuator 3 is appropriately equipped with a first polarizing plate, a half-wave plate that can rotate around the optical axis of the illumination light, and a second polarizing plate. The light that enters the attenuator 3 is converted into linearly polarized light by the first polarizing plate, and the polarization direction is rotated in any direction depending on the azimuth of the slow axis of the half-wave plate, and passes through the second polarizing plate. The light intensity is reduced at any ratio by controlling the azimuth of the half-wave plate. When the linear polarization degree of the light incident on the attenuator 3 is sufficiently high, the first polarizing plate is not necessarily required. The attenuator 3 used has a relationship between the input signal and the light attenuation rate calibrated in advance. As the attenuator 3, it is possible to use an ND filter having a gradation density distribution, or to switch between a plurality of ND filters with different densities.

The emitted light adjustment unit 4 has a plurality of reflecting mirrors. Here, an example in the case of two reflecting mirrors is described, but the present invention is not limited to this and three or more reflecting mirrors may be used as appropriate. Here, a three-dimensional Cartesian coordinate system (XYZ coordinates) is provisionally defined, and it is assumed that the incident light on the reflecting mirror travels in the +X direction. A first reflecting mirror is installed to deflect the incident light in the +Y direction (incident and reflected in the XY plane), and a second reflecting mirror is installed to deflect the light reflected by the first reflecting mirror in the +Z direction (incident and reflected in the YZ plane). The position and traveling direction (angle) of the light emitted from the emitted light adjustment unit 4 are adjusted by translating each of the reflecting mirrors and adjusting the swing angle. As described above, by arranging the first reflecting mirror and the second reflecting mirror such that the entrance/reflection surface (XY plane) of the first reflecting mirror and the entrance/reflection surface (YZ plane) of the second reflecting mirror are perpendicular to each other, it is possible to independently adjust the position and angle in the XZ plane and the position and angle in the YZ plane of the light (traveling in the +Z direction) emitted from the emitted light adjustment unit 4.

The beam expander 5 has two or more lens groups and has the function of expanding the diameter of the incident parallel light beam. For example, a Galileo type beam expander equipped with a combination of concave and convex lenses is used. The beam expander 5 is installed on a translation stage with two or more axes, and its position can be adjusted such that the center coincides with a predetermined beam position. In addition, the beam expander 5 as a whole is provided with a swing angle adjustment function such that the optical axis of the beam expander 5 coincides with a predetermined beam optical axis. The expansion rate of the light beam diameter can be controlled by adjusting the distance between the lenses (zoom mechanism). When the light incident on the beam expander 5 is not parallel, the diameter of the light beam is expanded and collimated (the light beam is made quasi-parallel) at the same time by adjusting the distance between the lenses. The light beam may be collimated by installing a collimating lens upstream of the beam expander 5, independent of the beam expander 5. The expansion magnification of the beam diameter by the beam expander 5 is about 5 to 10 times, and the beam emitted from the light source with a diameter of 1 mm is expanded to about 5 to 10 mm.

The polarization control unit 6 is configured with a half-wave plate and a quarter-wave plate, and controls the polarization state of the illumination light to any polarization state. The state of the light incident on the beam expander 5 and the light incident on the illumination intensity distribution control unit 7 is measured by a beam monitor 22 in the middle of the optical path of the illumination unit 101.

FIGS. 2 to 6 are schematic diagrams of the positional relationship between the illumination optical axis 120 guided to the sample surface by the illumination unit 101 and the illumination intensity distribution shape. Note that the configuration of the illumination unit 101 in FIGS. 2 to 6 shows only a part of the configuration of the illumination unit 101, and the emitted light adjustment unit 4, mirror 21, beam monitor 22, etc. are omitted.

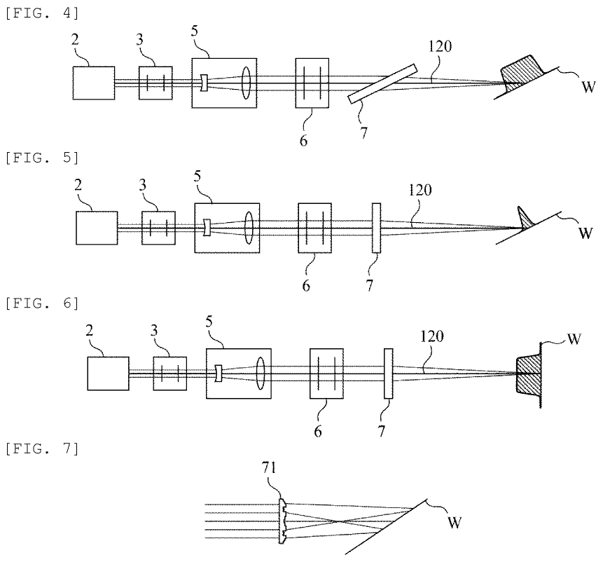

FIG. 2 is a schematic diagram of a cross section of the incident plane of oblique incidence illumination (a plane including the illumination optical axis and the sample surface normal). The oblique incidence illumination is inclined with respect to the sample surface in the incident plane. The illumination unit 101 creates a substantially uniform illumination intensity distribution in the incident plane. The length of the part with uniform illumination intensity is about 100 μm to 4 mm in order to inspect a wide area per unit time. FIG. 3 shows a schematic diagram of a cross section of a plane including the sample surface normal and perpendicular to the incident plane of oblique incidence illumination. In this plane, the illumination intensity distribution on the sample surface is an illumination intensity distribution in which the intensity at the periphery is weaker than at the center. More specifically, the illumination intensity distribution is a Gaussian distribution reflecting the intensity distribution of the light incident on the illumination intensity distribution control unit 7, or an intensity distribution similar to a first-order Bessel function of the first kind or a sinc function reflecting the aperture shape of the illumination intensity distribution control unit 7. The length of the illumination intensity distribution in this plane (the length of the region having an illumination intensity of 13.5% or more of the maximum illumination intensity) is shorter than the length of the portion in the incident plane where the illumination intensity is uniform, and is about 2.5 μm to 20 μm, in order to reduce haze generated from the sample surface. The illumination intensity distribution control unit 7 includes optical elements such as an aspheric lens, a diffractive optical element, a cylindrical lens array, and a light pipe, which will be described later. The optical elements configuring the illumination intensity distribution control unit 7 are installed perpendicular to the illumination optical axis, as shown in FIGS. 2 and 3.

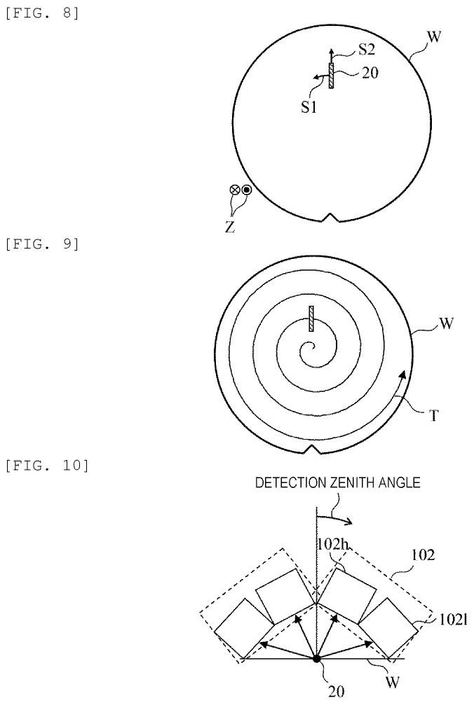

It is also possible to install the optical elements configuring the illumination intensity distribution control unit 7 tilted to the optical axis, as shown in FIG. 4. As shown in FIGS. 5 and 6, it is also possible to replace the intensity distribution on the incident plane of the oblique incidence illumination shown in FIGS. 2 and 3 with the intensity distribution on a plane perpendicular to the incident plane. That is, it is also possible to configure the portion with uniform illumination intensity on the incident plane to be shorter than the portion with uniform illumination intensity on the plane perpendicular to the incident plane.

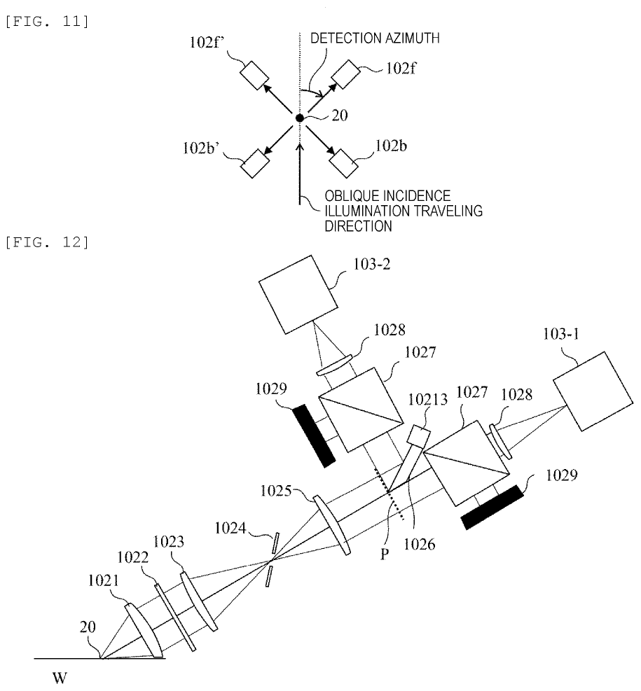

The illumination intensity distribution control unit 7 includes optical elements that act on the phase distribution and intensity distribution of the incident light. A diffractive optical element (DOE) 71 is used as the optical element configuring the illumination intensity distribution control unit 7 (FIG. 7). The diffractive optical element 71 has a fine undulating shape with dimensions equal to or smaller than the wavelength of the light on the surface of a substrate made of a material that transmits the incident light. For ultraviolet light, fused quartz is used as the material that transmits the incident light. In order to reduce attenuation of light caused by passing through the diffractive optical element 71, one coated with an anti-reflection film may be used. Lithography is used to form the fine undulating shape of the diffractive optical element. The light that has become quasi-parallel after passing through the beam expander 5 passes through the diffractive optical element 71, forming an illumination intensity distribution on the sample surface according to the undulating shape of the diffractive optical element 71. The undulating shape of the diffractive optical element 71 is designed and manufactured to a shape calculated based on Fourier optics theory such that the illumination intensity distribution formed on the sample surface is a long and uniform distribution in the incident plane. The optical element provided in the illumination intensity distribution control unit 7 includes a translation adjustment mechanism with two or more axes and a rotation adjustment mechanism with two or more axes such that the relative position and angle of the incident light with respect to the optical axis can be adjusted. In addition, a focus adjustment mechanism that moves in the optical axis direction is provided. As an alternative optical element having the same function as the diffractive optical element 71, an aspheric lens, a combination of a cylindrical lens array and a cylindrical lens, or a combination of a light pipe and an imaging lens may be used.

Modifications of the illumination intensity distribution created on the sample surface by the illumination unit 101 will be described. As an alternative to an illumination intensity distribution that is long (linear) in one direction and has a substantially uniform intensity in the longitudinal direction, it is also possible to use an illumination intensity distribution that has a Gaussian distribution in the longitudinal direction. Gaussian distribution illumination that is long in one direction can be created by having a spherical lens in the illumination intensity distribution control unit 7 and forming an elliptical beam that is long in one direction using the beam expander 5, or by configuring the illumination intensity distribution control unit 7 with a plurality of lenses including a cylindrical lens. Part or all of the spherical lens or cylindrical lens in the illumination intensity distribution control unit 7 are placed parallel to the sample surface, forming an illumination intensity distribution that is long in one direction on the sample surface and has a narrow width in the direction perpendicular to that. Compared to creating a uniform illumination intensity distribution, the illumination intensity distribution on the sample surface fluctuates less due to fluctuations in the state of the light incident on the illumination intensity distribution control unit 7, the illumination intensity distribution is highly stable. The light transmittance is higher and more efficient than when a diffractive optical element or a microlens array is used for the illumination intensity distribution control unit 7.

The state of the illumination light in the illumination unit 101 is measured by the beam monitor 22. The beam monitor 22 measures and outputs the position and angle (traveling direction) of the illumination light that has passed through the emitted light adjustment unit 4, or the position and wavefront of the illumination light that is incident on the illumination intensity distribution control unit 7. The position measurement of the illumination light is performed by measuring the position of the center of gravity of the light intensity of the illumination light. Examples of specific position measurement means include an optical position sensor (PSD: Position Sensitive Detector) or an image sensor such as a CCD sensor or CMOS sensor. The angle measurement of the illumination light is performed by an optical position sensor or an image sensor installed at a position farther away from the light source than the position measurement means, or at the position where the light is focused by a collimating lens. The illumination light position and illumination light angle detected by the sensor are input to the control unit 53 and displayed on the display unit 54. When the illumination light position or angle deviates from the predetermined position or angle, it is adjusted by the emitted light adjustment unit 4 to return to the predetermined position.

The wavefront measurement of the illumination light is performed to measure the parallelism of the light incident on the illumination intensity distribution control unit 7. When the wavefront measurement shows that the light incident on the illumination intensity distribution control unit 7 is not quasi-parallel light but is diverging or converging, the lens group of the beam expander 5 in the front is displaced in the optical axis direction to make the light closer to quasi-parallel light. When the wavefront measurement shows that the wavefront of the light incident on the illumination intensity distribution control unit 7 is partially inclined, by inserting a spatial light phase modulation element, which is a type of spatial light modulator (SLM), to the front of the illumination intensity distribution control unit 7 and giving an appropriate phase difference to each position of the light beam cross section such that the wavefront becomes flat, the wavefront can be made closer to flat, that is, the illumination light can be made closer to quasi-parallel light. By the above wavefront accuracy measuring and adjusting means, the wavefront accuracy (deviation from a predetermined wavefront (design value or initial state)) of the light incident on the illumination intensity distribution control unit 7 is reduced to λ/10 rms or less.

The illumination intensity distribution on the sample surface adjusted by the illumination intensity distribution control unit 7 is measured by the illumination intensity distribution monitor 24. As shown in FIG. 1, even when vertical illumination is used, the illumination intensity distribution on the sample surface adjusted by the illumination intensity distribution control unit 7v is similarly measured by the illumination intensity distribution monitor 24. The illumination intensity distribution monitor 24 forms the image of the sample surface on the image sensor such as a CCD sensor or a CMOS sensor via a lens, and detects an image. The image of the illumination intensity distribution detected by the illumination intensity distribution monitor 24 is processed by the control unit 53, and the position of the center of gravity of intensity, the maximum intensity, the position of the maximum intensity, the width and length of the illumination intensity distribution (the width and length of the illumination intensity distribution region where the intensity is equal to or greater than a predetermined intensity or is equal to or greater than a predetermined ratio of the maximum intensity value), etc. are calculated and displayed on the display unit 54 together with the contour shape and cross-sectional waveform of the illumination intensity distribution.

When performing oblique incidence illumination, the height displacement of the sample surface causes the position of the illumination intensity distribution to be displaced and the illumination intensity distribution to be disturbed due to defocus. To prevent this, the height of the sample surface is measured and, when the height deviates, the deviation is corrected by the illumination intensity distribution control unit 7 or by adjusting the height by the Z-axis stage 104.

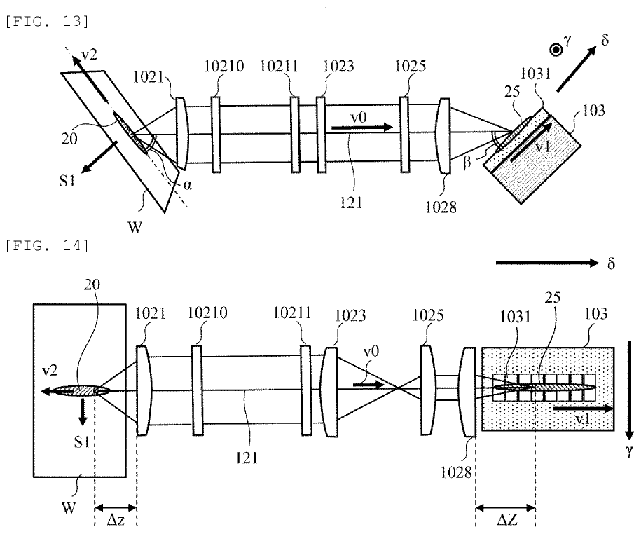

The illuminance distribution shape (illumination spot 20) formed on the sample surface by the illumination unit 101 and the sample scanning method will be described with reference to FIGS. 8 and 9. A circular semiconductor silicon wafer is assumed as the sample W. The stage 104 is equipped with a translation stage, a rotation stage and a Z stage for adjusting the height of the sample surface (none of which are shown). As mentioned above, the illumination spot 20 has a long illumination intensity distribution in one direction, which is designated S2 and the direction substantially perpendicular to S2 is designated S1. Scanning is performed in the circumferential direction S1 of a circle centered on the rotation axis of the rotation stage due to the rotational motion of the rotation stage, and in the translation direction S2 of the translation stage due to the translational motion of the translation stage. While the sample is rotated once by scanning in the scanning direction S1, scanning is performed in the scanning direction S2 by a distance equal to or less than the longitudinal length of the illumination spot 20, so that the illumination spot traces a spiral trajectory T on the sample W and the entire surface of the sample W is scanned.

The detection unit that divides a pupil will be described below.

An example of the arrangement of the detection unit 102 with respect to the sample W and the illumination spot 20 will be described with reference to FIGS. 10 to 12. FIG. 10 shows a side view of the arrangement of the detection unit 102. The angle between the normal to the sample W and the detection direction of the detection unit is defined as a detection zenith angle. The detection unit 102 includes a high-angle detection unit 102h whose detection zenith angle is equal to or less than a predetermined angle, and a low-angle detection unit 1021 whose detection zenith angle is equal to or more than a predetermined angle. The configuration of the optical system of the detection unit 102 will be described later with reference to FIG. 12, but each of the high-angle detection unit 102h and the low-angle detection unit 1021 detects scattered light using a common objective lens, and the scattered light is branched at the Fourier plane of the objective lens. In the present embodiment, the boundary between the detection zenith angle of the high-angle detection unit 102h and the detection zenith angle of the low-angle detection unit 1021 can be easily changed.

Although one detection unit 102 is shown in FIG. 1, a plurality of detection units 102 are disposed so as to detect scattered light emitted from the illumination spot 20 in a plurality of directions. FIG. 11 shows a plan view of the arrangement of the detection unit 102. The angle between the traveling direction of the oblique incidence illumination and the detection direction in a plane parallel to the surface of the sample W is defined as a detection azimuth. The detection unit 102 appropriately includes a front detection unit 102f, a rear detection unit 102b, and a front detection unit 102f′ and a rear detection unit 102b′ that are positioned symmetrically to the front detection unit 102f and the rear detection unit 102b with respect to the illumination incident plane. For example, the front detection unit 102f is installed at a detection azimuth of 0 degrees or more and 90 degrees or less, and the rear detection unit 102b is installed at a detection azimuth of 90 degrees or more and 180 degrees or less. Without being limited thereto, the number and positions of the detection units may be changed appropriately.

FIG. 12 shows an example of a specific configuration diagram of the detection unit 102. The scattered light generated from the illumination spot 20 is collected by the objective lens 1021, and the polarization direction is controlled by the polarization control filter 1022. The polarization control filter 1022 may be, for example, a half-wave plate whose rotation angle can be controlled by a driving mechanism such as a motor. In order to efficiently detect scattered light, it is preferable that the detection NA of the objective lens 1021 is 0.3 or more. If necessary, the lower end of the objective lens 1021 is cut out such that the lower end of the objective lens 1021 does not interfere with the sample surface W. The imaging lens 1023 forms an image of the illumination spot 20 at the position of the aperture 1024. The aperture 1024 is set to pass only light of the region that is detected by the photoelectric conversion unit 103, from the image of the illumination spot 20. When the illumination spot 20 has a Gaussian distribution profile in the S2 direction, the aperture 1024 passes only the central part of the Gaussian distribution where the light intensity is strong in the S2 direction, and blocks the regions at the ends of the beam where the light intensity is weak. Further, with the size approximately the same as the image formed of the illumination spot 20 in the S1 direction, disturbances such as air scattering that occur when the illumination passes through the air is prevented. The condenser lens 1025 re-collects the formed image of the aperture 1024.

The knife edge (branching optical member) 1026 is arranged such that its tip is located at the Fourier plane (pupil plane) P of the objective lens 1021. The knife edge 1026 branches, for example, into the high-angle detection unit 102h whose detection zenith angle is 45 degrees or less and the low-angle detection unit 1021 whose detection zenith angle is 45 degrees or more. The knife edge 1026 is equipped with a linear motion mechanism 10213, and can move the boundary of the divided region with respect to the pupil plane P. An example of the linear motion mechanism is a linear stage. As a result, the division angle of the zenith angle is not necessarily 45 degrees and can be changed as appropriate.

A polarizing beam splitter 1027 separates the light whose polarization direction has been converted by the polarization control filter 1022 according to its polarization direction. A diffuser 1029 absorbs light whose polarization direction is not used for detection by the photoelectric conversion unit 103. This prevents unnecessary light from becoming stray light. An imaging lens 1028 forms an image of the illumination spot 20 on the photoelectric conversion unit 103. A cylindrical lens can also be used as the imaging lens 1028 to form an image in only one direction. In the present embodiment, the polarization control filter 1022 is a half-wave plate, and in combination with the polarizing beam splitter 1027, only light of a specific polarization direction from the light collected by the objective lens 1021 is detected by the photoelectric conversion unit 103. However, it is also possible to use a wire grid polarizing plate with a transmittance of 80% or more as the polarization control filter 1022 and extract only light of a desired polarization direction without using the polarizing beam splitter 1027.

In the optical system of the detection unit shown in FIG. 12, the optical system from the objective lens 1021 to the condenser lens 1025 is sometimes called a condensing optical system, and the optical system from the condenser lens 1025 to the photoelectric conversion unit 103 is sometimes called the imaging optical system.

FIGS. 13 and 14 show examples of the arrangement of the photoelectric conversion unit 103. The optical axis 121 is inclined with respect to the normal direction of a light receiving unit 1031. The light receiving unit 1031 of the photoelectric conversion unit 103 is arranged parallel to the longitudinal direction of the optical image 25 formed on the light receiving unit 1031 by the detection unit 102 from the linear illumination spot 20 applied to the surface of the sample W. The pair of cylindrical lenses 10210, 10211 form a cylindrical beam expander, and the spread of the optical image 25 formed by the illumination spot 20 in the short-side direction γ is smaller than the spread of the optical image 25 in the longitudinal direction.

The photoelectric conversion unit 103 captures the optical image 25 and outputs it as an electrical signal. The photoelectric conversion unit 103 has an array-like light receiving unit 1031 and an anti-reflection film (not shown) at a position conjugate with the illumination spot 20 applied to the surface of the sample W. The light receiving surface of the photoelectric conversion unit 103 is not conjugate with the sample surface in the short-side direction γ. However, since the short-side direction γ is also the short-side direction of the illumination spot 20, the image height of the optical image 25 is low and defocusing hardly occurs. Therefore, by increasing the imaging magnification of the optical image 25 in the short-side direction γ, it is possible to reduce the variation in the incidence angle to the light receiving unit 1031.

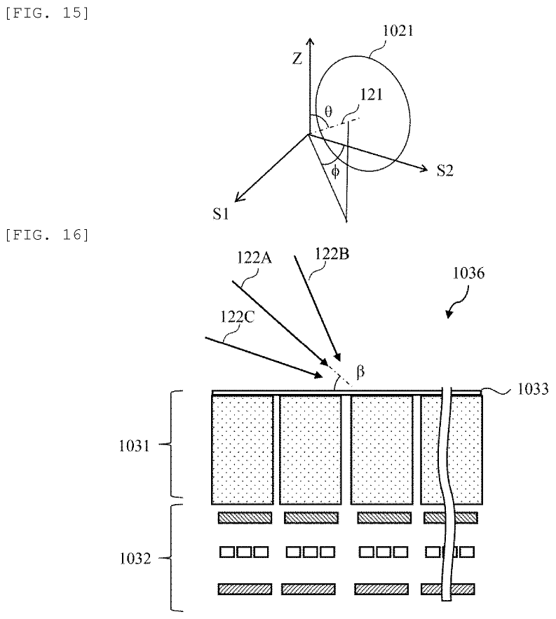

FIG. 15 shows a schematic diagram of the three-dimensional arrangement of the sample W and the detection unit 102. The optical axis 121 of the detection unit 102 is inclined by an angle θ (zenith angle) with respect to the normal direction Z of the sample W. The projection of the optical axis 121 onto the sample surface is inclined by an angle φ (azimuth) with respect to the longitudinal direction S2 of the illumination spot 20.

In this way, when the optical axis 121 for detecting the light of the detection unit 102 is deviated by an angle θ with respect to the normal direction Z of the sample W and by an angle φ with respect to the longitudinal direction S2 of the illumination spot 20, then in three-dimensional space, this optical axis 121 is represented by a vector v0 shown as (Equation 1).

$$v 0 = ( sin θ \cdot sin ϕ , sin θ \cdot cos ϕ \cdot cos θ ) \qquad ( Equation 1 )$$

The angle α between the vector v0 and the longitudinal direction S2 of the illumination spot 20 can be found by (Equation 2).

$$α = arccos ( sin θ \cdot cos ϕ ) \qquad ( Equation 2 )$$

At this time, the defect inspection device 10 detects a section of 2L in the longitudinal direction S2 of the illumination spot 20 by the photoelectric conversion unit 103. Depending on the position x from the center of the field of view, the working distance (the distance between the sample W and the detection unit 102) Δz is expressed as (Equation 3).

$$Δ z = x ( sin θ \cdot cos ϕ ) , \vert x \vert < L \qquad ( Equation 3 )$$

In (Equation 3), |x|<L indicates that the distance from the center of the field of view is equal to or less than L, that is, the position is within the illumination spot 20. The same applies to (Equation 4).

The imaging magnification M is determined by the condenser lens 1025 and the imaging lens 1028. The position AZ of the image formed here is expressed as (Equation 4).

$$Δ Z = {M}^{2} \times ( sin θ \cdot cos ϕ ) , \vert x \vert < L \qquad ( Equation 4 )$$

Generally, a line sensor is arranged to be perpendicular to the optical axis 121, which is the center of the light beam emitted by the imaging lens 1028. However, in the present embodiment, by tilting the photoelectric conversion unit 103, imaging detection without defocusing is implemented regardless of changes in the working distance Δz within the field of view. At this time, the optical axis 121 incident on the photoelectric conversion unit 103 and the pixel arrangement vector v1 of the light receiving surface are in a plane spanned by the longitudinal direction S2 of the illumination spot 20 and the vector v0, and the angle β between the vectors v1 and v0 is set to satisfy (Equation 5).

$$tan α = M \cdot tan β \qquad ( Equation 5 )$$

Here, angle α is the angle between longitudinal vector v2 of illumination spot 20 and vector v0, and satisfies (Equation 6).

$$cos α = sin θ \cdot cos ϕ \qquad ( Equation 6 )$$

From (Equation 5), as the imaging magnification M increases, the angle β between vectors v0 and v1 decreases and the incidence angle increases. When M=2, the light ray with the largest incidence angle is incident on the photoelectric conversion unit 103 at an angle close to 90 degrees. The absorptance of the anti-reflection film of photoelectric conversion unit 103 depends on the incidence angle, and the absorptance becomes very small at incidence angles close to 90 degrees. To prevent this, it is desirable to set the imaging magnification M to 2 times or less.

Under these conditions, the angle β between the optical axis 121 incident on the photoelectric conversion unit 103 from the imaging lens 1028 and the vector v1 can be maximized. When the numerical aperture of the incident light beam on the condenser lens 1025 is N, the spread of the light beam emitted to the photoelectric conversion unit 103 is the reciprocal of the imaging magnification M multiplied by the spread of the light beam emitted to the imaging lens 1028.

As described above, in order to set the imaging magnification M to 2 times or less, particularly when a lens with a large numerical aperture is used as the objective lens 1021, light is incident on the photoelectric conversion unit 103 from a wide range of directions. Due to the characteristics of the anti-reflection film, if the range of incidence angle of light on the photoelectric conversion unit 103 is wide, the light absorptance of the photoelectric conversion unit 103 is low, making it difficult to achieve high sensitivity. Therefore, the imaging magnification M is set to 1 time or more. As a result, angle β becomes smaller than angle α, and typically becomes smaller by 5 degrees or more when a magnification of about 1.3 times is applied.

FIG. 16 shows a cross-sectional configuration diagram of the image sensor 1036 configuring photoelectric conversion unit 103. The image sensor 1036 is configured with an anti-reflection film 1033, a light receiving unit 1031, and a wiring unit 1032, which are stacked in order from the surface. Incident light 122A to 122C is light that enters the image sensor 1036.

Incident light 122A is light on the optical axis 121 shown in FIGS. 13 and 14. Incident light 122B, 122C is light that enters at angles different from the optical axis 121. The anti-reflection film 1033 is a film for preventing surface reflection of incident light 122A to 122C. The light receiving unit 1031 is in an array shape, and performs photoelectric conversion for each divided region, i.e., pixel. The wiring unit 1032 independently extracts electricity output by the light receiving unit 1031 to the outside. As described above, sensors with a structure in which the light receiving unit 1031 is located closer to the light incident side than the wiring unit 1032 are known as back side illumination sensors. In the present embodiment, incident light 122 is incident at a predetermined angle deviated from the normal direction of the light receiving unit 1031. Therefore, in a CMOS image sensor known as Front side Illumination (FSI) and with a structure in which the wiring unit is on the light incident side, light is absorbed by the wiring unit, and sufficient light cannot be incident on the light receiving unit.

As shown by incident light 122A to 122C, light is incident on the light receiving unit 1031 from various directions. For this reason, unless the anti-reflection film 1033 has high absorptance for these incident lights 122A to 122C, good sensitivity cannot be obtained.

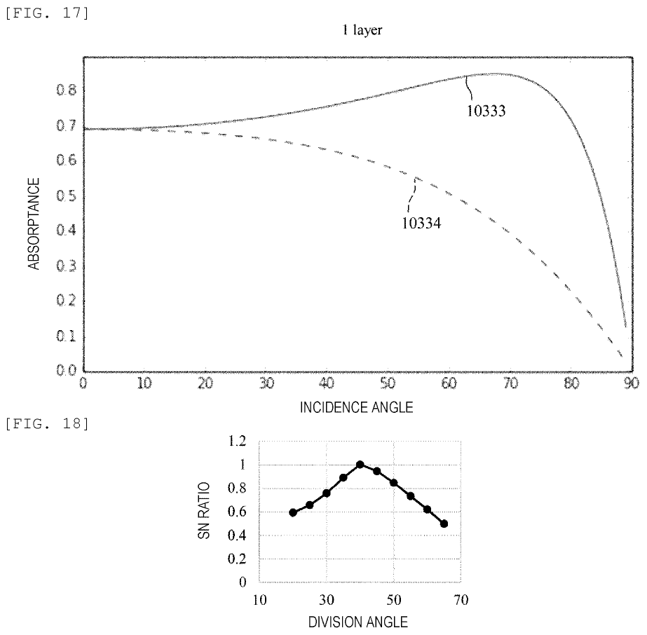

FIG. 17 is a graph showing the characteristics of the anti-reflection film 1033 formed from a single layer of 25 nm HfO₂. The horizontal axis of the graph shows the incidence angle, and the vertical axis of the graph shows the absorptance. Curve 10333 shows the absorptance characteristics for S-polarized light, and curve 10334 shows the absorptance characteristics for P-polarized light. The absorptance of P-polarized light decreases as the incidence angle increases, but the absorptance drops to 0.5 when the incidence angle is around 60 degrees. Furthermore, the incidence angle for S-polarized light increases up to about 70 degrees, and shows an absorptance of 70% or more in the range of incidence angle from 0 to 80 degrees. However, in order to implement image detection without defocusing regardless of changes in the working distance within the field of view, the photoelectric conversion units 103-1 and 103-2 need to be tilted by a predetermined angle. In other words, it is desirable to tilt the normal to the light receiving surface of the photoelectric conversion unit 103-1 by, for example, 10 to 80 degrees from the optical axis 121 of the detection unit 102.

<Pupil Division Adjustment Using a Knife Edge with a Linear Motion Mechanism>

A method for adjusting the pupil division of the detection unit according to the inspection target or inspection conditions will be described. The intensity distributions of scattered light from defects and background scattered light differ depending on the condition of the sample surface as the inspection target. For example, in the case of a film-coated wafer that has undergone an oxidation process of forming a protective film covering the semiconductor wafer surface during a semiconductor manufacturing process, the SN ratio (ratio of defect scattered light to background scattered light) on the low-angle detector side, which has a larger detection zenith angle, is higher than in the case of a bare wafer without a film. For this reason, the sensitivity can be improved by widening the aperture of the low-angle detector for a film-coated wafer. Therefore, the division angle is adjusted and the distribution of the aperture is changed by moving the knife edge 1026 with the linear motion mechanism 10213 (see FIG. 12) according to the inspection target. The linear motion mechanism 10213 and the knife edge 1026 may collectively be referred to as a pupil division mechanism.

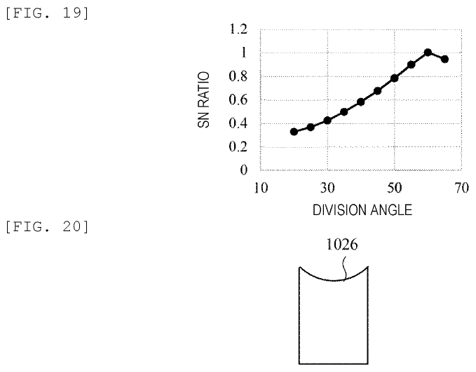

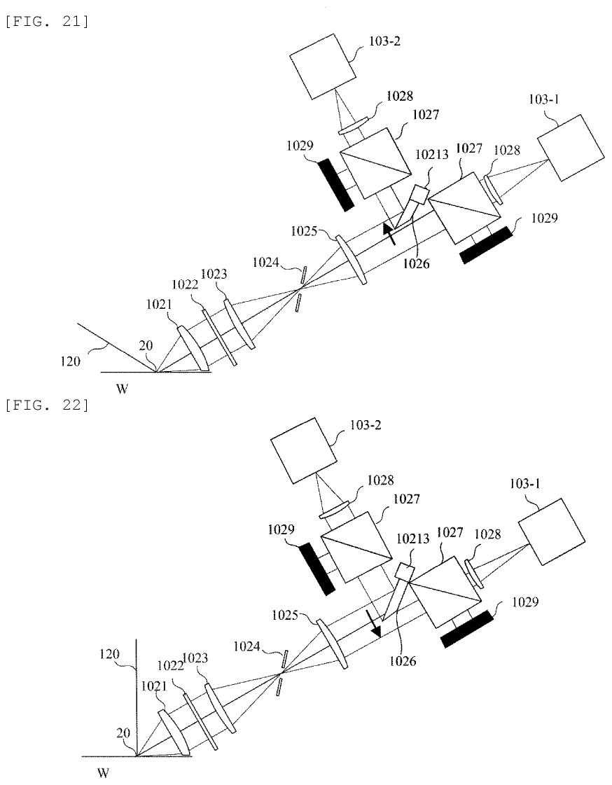

FIGS. 18 and 19 are graphs showing the characteristics of defect measurement sensitivity with respect to the division angle of the zenith angle by the knife edge 1026. FIG. 18 is a graph in which a bare wafer is an inspection target, and FIG. 19 is a graph in which a film-coated wafer is an inspection target. The highest sensitivity can be obtained by setting the division angle to 40 degrees (see FIG. 18) when an inspection target is a bare wafer, and setting the division angle to 60 degrees (see FIG. 19) when an inspection target is a wafer with an oxide film.

Here, the pupil division angle is set for each of the plurality of detection units. Depending on the intensity distribution of the scattered light, the sensitivity can be improved by setting different division angles for the front detection unit 102f and the rear detection unit 102b.

The cutting edge of the knife edge 1026 is placed on the pupil plane P of the condenser lens 1025. Depending on the configuration of the optical system, it may be a relay position of the pupil plane P. Here, no distinction is made and the term pupil plane P is used. The division method can be easily adjusted by moving the knife edge 1026 with a linear motion mechanism such as a linear stage. The direction in which the knife edge 1026 is moved by the linear motion mechanism 10213 is parallel to the pupil plane P. This ensures that the cutting edge of the knife edge 1026 is always within the pupil plane regardless of the position of the knife edge 1026. When the cutting edge of the knife edge 1026 is defocused with respect to the pupil plane P, the pupil division boundary changes depending on the angle at which the light rays are incident on the pupil, that is, the position within the field of view. In contrast, by placing the cutting edge of the knife edge 1026 on the pupil plane P, the effect of keeping the pupil division boundary constant regardless of the position within the field of view can be achieved.

FIG. 20 shows an example of the shape of the knife edge 1026. When the cutting edge of the knife edge 1026 is straight, the branching zenith angle θ will not be constant with respect to the azimuth p. In order to divide the pupil at a constant zenith angle θ regardless of the azimuth cp, the shape of the cutting edge is curved to reduce changes in the pupil allocation in the zenith angle direction depending on the azimuth. The curvature of the shape of the cutting edge of the knife edge 1026 is determined by the focal length of the condenser lens 1025 and the angle of the knife edge 1026 with respect to the optical axis 121.

Furthermore, sensitivity can be improved by adjusting the pupil division of the detection unit taking into consideration not only the inspection target but also the inspection conditions. For example, the intensity distribution of scattered light changes depending on the incidence angle of the illumination, so it is effective to adjust the pupil division. FIG. 21 shows the case of oblique incidence illumination in which the illumination optical axis 120 is inclined with respect to the sample surface. In oblique incidence illumination, the sensitivity can be increased by moving the knife edge 1026 to widen the aperture of the low-angle detector. On the other hand, in the case of perpendicular illumination as shown in FIG. 22, higher sensitivity can be achieved by moving the knife edge 1026 to widen the aperture of the high-angle detector.

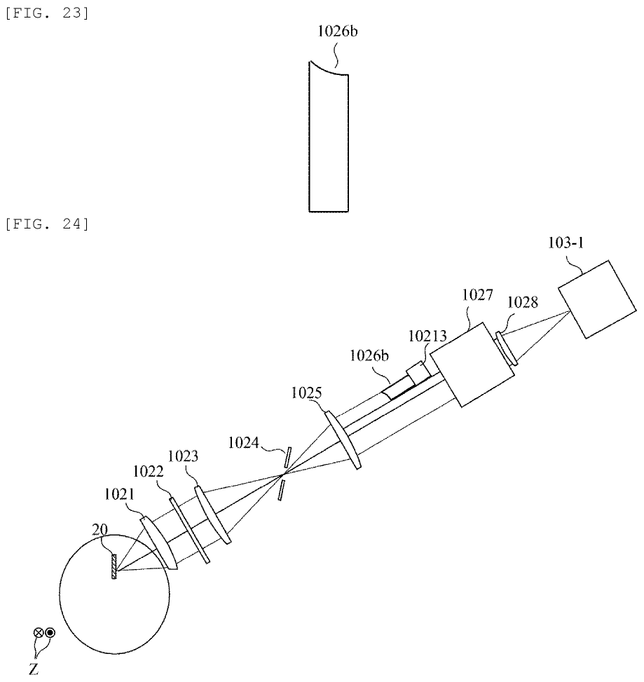

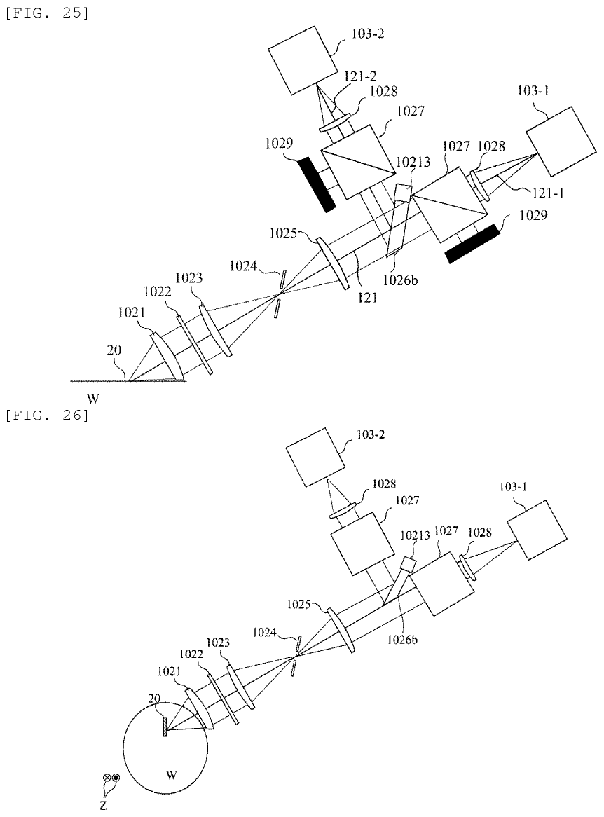

Furthermore, the pupil division can be changed according to the defect type to be detected. The knife edge 1026 is moved to change the division angle in the apex angle direction according to the angular distribution of the scattered light of the defect type. Depending on the shape of the defect type, it may be effective to divide in the azimuth direction instead of the zenith angle direction. The optimum pupil division for a given defect type shape can be found by simulation. Therefore, an optical simulation is performed in advance for the defect type to be detected to find the preferred pupil division direction and division position. The pupil division information shown by the simulation is stored in the control unit 53, and the pupil division information that results in the optimum pupil division according to the inspection content is called up to control the pupil division mechanism. When dividing the pupil in the azimuth direction, the pupil can also be divided in the azimuth direction by using a knife edge 1026b whose width in the azimuth direction is changed as shown in FIG. 23 and arranged as shown in FIGS. 24 and 25.

When dividing the pupil in the azimuth direction, in the arrangement of FIGS. 24 and 25, the cutting edge of the knife edge 1026b is inclined with respect to the pupil plane, so that the cutting edge of the tip is defocused with respect to the pupil plane and the pupil cannot be divided accurately. To divide the pupil accurately, it is effective to make the optical axis 121-2 of the detection unit after branching perpendicular to the Z axis (parallel to the sample surface) as shown in FIG. 26. However, when the optical axis is made completely perpendicular to the Z axis, accurate pupil division is not possible when branching in the zenith angle. When selectively using division in the zenith angle direction and division in the azimuth direction, it is advisable to determine the direction of the optical axis 121-2 after branching such that the errors in both pupil divisions are within the tolerance range.

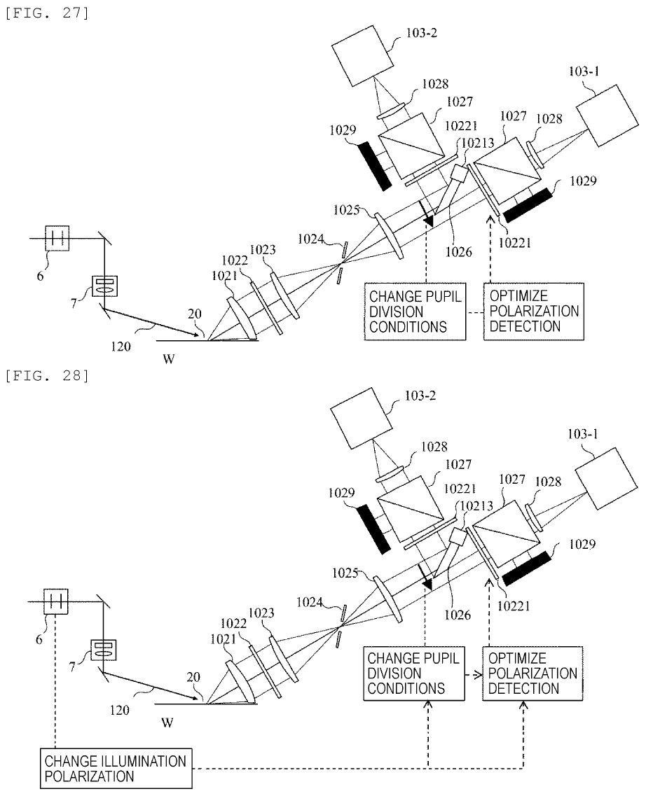

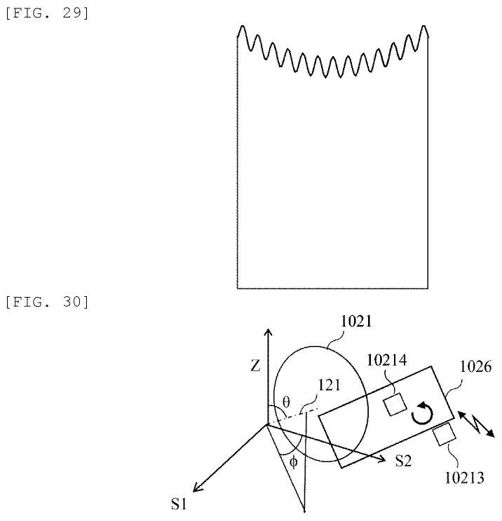

Because the background scattered light and the scattered light from defects have different polarization characteristics, sensitivity can be improved by inserting an analyzer into the detection unit to reduce the amount of background scattered light received. When the pupil division is changed, the polarization information of the background scattered light detected by each detection unit also changes, so sensitivity can be further improved by optimizing the polarization to be detected. For example, a half-wave plate is used as the polarization control filter 1022, and the angle of the half-wave plate is appropriately adjusted to adjust the polarization transmitted through the polarizing beam splitter 1027. Alternatively, as shown in FIG. 27, after the optical path is branched by the knife edge 1026, half-wave plates 10221 may be placed in front of the polarizing beam splitter 1027, and the angle of the half-wave plate may be optimized for each detection unit. The knife edge 1026 can be driven by the linear motion mechanism 10213, and the polarization control filter 1022 and the half-wave plate 10221 can be rotated around the optical axis by a driving mechanism such as a motor, and all are controlled by the control unit 53. The amount of control may be adjusted by the user, or a table designating the amount of control may be stored in advance.

It is also effective to consider the polarization of the illumination when adjusting the pupil division. Changing the polarization of the illumination also changes the intensity distribution of the scattered light. Therefore, sensitivity can be improved by searching for the polarization conditions of the illumination and the pupil division conditions that make it easier to detect the scattered light from the defect. For example, as shown in FIG. 28, when the polarization of the illumination is set to S-polarized by the polarization control unit 6, in the case of oblique incidence illumination, the aperture of the high-angle detector can be widened to increase the sensitivity. In addition, when the polarization of the illumination changes, the polarization characteristics of the scattered light also change. Therefore, the sensitivity can be further improved by adjusting the pupil division conditions according to the polarization of the illumination and optimizing the polarization of the scattered light to be detected according to the change in the illumination and the adjusted pupil division conditions.

The signal processing unit 105 extracts defects by processing a plurality of signals output from the photoelectric conversion units 103 of each detection unit. In this time, the sensitivity can be improved by weighting and adding signals to each other such that the proportion of signals from the detection units with low noise becomes relatively large. This weighting coefficient is calculated by comparing the intensities of the background scattered light detected by the detection units. For example, since the background scattered light generated from the sample surface has a strong distribution toward the rear of the irradiation direction of the oblique incidence illumination, the weighting coefficient can be determined such that the proportion of the signal detected by the front detection unit 102f is greater than that of the rear detection unit 102b.

When the pupil division is changed, the intensity ratio of the background scattered light between the branched detection units also changes. By optimizing the weighting coefficient between the signals according to the pupil division, the ratio of signals from the detection units with low noise increases, and sensitivity is further improved.

When the pupil is divided using a knife edge, ringing artifacts occur due to diffraction that occurs at the cutting edge, and imaging performance deteriorates. Ringing artifacts occur when high-frequency components are sharply cut off at the pupil plane, which is the Fourier transform plane. To reduce this, it is effective to change the shape of the cutting edge of the knife edge 1026 and reduce the steepness of the frequency characteristics. For example, ringing artifacts can be reduced by giving the cutting edge a wavy pattern as shown in FIG. 29. The amplitude and frequency of the wavy pattern are determined by wave-optics calculations that take into account the effect of diffraction.

<Pupil Division Adjustment Using Knife Edge with Rotation Mechanism>

As shown in FIG. 30, in addition to the linear motion mechanism 10213, a rotation mechanism 10214 may be added to the knife edge 1026. The rotation axis of the rotation mechanism 10214 is perpendicular to the surface of the knife edge 1026. The direction in which the linear motion mechanism 10213 drives the knife edge 1026 is a direction that is not perpendicular to either the zenith angle direction or the azimuth direction, and is parallel to the pupil plane. By combining the rotation mechanism and the linear motion mechanism, the pupil can be divided at any zenith angle and azimuth without the need to replace the knife edge.

### <Pupil Division Adjustment by Digital Mirror Device>

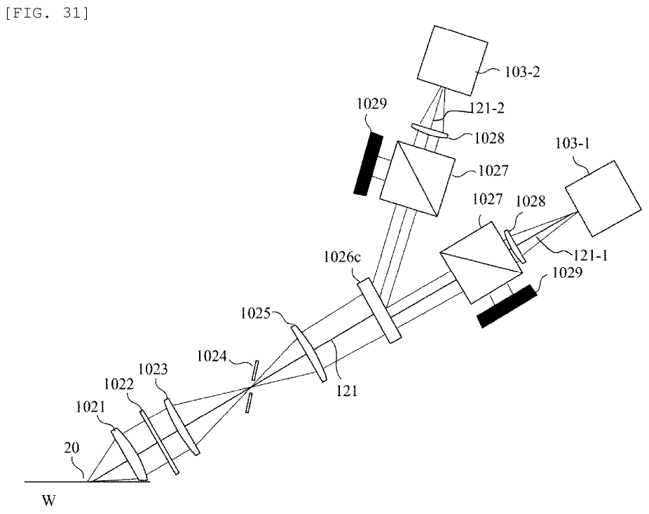

FIG. 31 shows an example of an optical system in which a digital mirror device (DMD) is used as the pupil division mechanism, and the pupil is divided by a DMD 1026c. The DMD is composed of micrometer-sized mirror pixels and can divide the pupil by switching the light reflection angle for each pixel. In FIG. 31, the DMD is placed at the position of the pupil plane of the condenser lens 1025 of the detection unit, perpendicular to the optical axis 121. In this case, since the dividing boundary is at the position of the pupil plane, the pupil can be divided accurately regardless of the position within the field of view.

In the high-angle detection unit 102h after branching in FIG. 31, the wavefront (equivalent phase surface) is inclined with respect to the optical axis 121-2. Therefore, the inclination of the image plane after passing through the imaging lens 1028 also changes. By adjusting the direction of the optical axis 121-2 and the focal length of the imaging lens, the angle between the photoelectric conversion unit 103-2 and the optical axis is reduced, thereby reducing the incidence angle to the sensor.

### REFERENCE SIGNS LIST

2: laser light source
3: attenuator
4: emitted light adjustment unit
5: beam expander
6: polarization control unit
7: illumination intensity distribution control unit
10: defect inspection device
20: illumination spot
21: mirror
22: beam monitor
24: illumination intensity distribution monitor
25: optical image
53: control unit
54: display unit
55: input unit
71: diffractive optical element
101: illumination unit
102: detection unit
103: photoelectric conversion unit
104: stage
105: signal processing unit
120: illumination optical axis
121: optical axis
122: incident light
1021: objective lens
1022: polarization control filter
1023: imaging lens
1024: aperture
1025: condenser lens
1026: knife edge
1026c: digital mirror device
1027: polarizing beam splitter
1028: imaging lens
1029: diffuser
1031: light receiving unit
1032: wiring unit
1033: anti-reflection film
1036: image sensor
10210, 10211: cylindrical lens
10221: half-wave plate
10213: linear motion mechanism
10214: rotation mechanism
10333, 10334: curve

1.-15. (canceled)

16. A defect inspection device comprising:
an illumination unit that irradiates a sample with illumination light emitted from a light source;
a detection unit that is disposed in an oblique direction with respect to the sample and detects scattered light generated from the sample;
a pupil division mechanism that divides pupil of the detection unit into a first detection angle and a second detection angle;
a first photoelectric conversion unit that converts scattered light at the first detection angle detected by the detection unit into an electrical signal;
a second photoelectric conversion unit that converts scattered light at the second detection angle detected by the detection unit into an electrical signal; and
a signal processing unit that processes the electrical signals converted by the first photoelectric conversion unit and the second photoelectric conversion unit to detect a defect in the sample, wherein
the pupil division mechanism divides the pupil such that pupil allocation corresponds to an inspection target or inspection conditions, and
the signal processing unit performs weighted addition of the signal from the first photoelectric conversion unit and the signal from the second photoelectric conversion unit using a weighting coefficient determined according to the pupil allocation by the pupil division mechanism.

17. The defect inspection device according to claim 16, wherein
the pupil division mechanism divides the pupil in a zenith angle direction or an azimuth direction.

18. The defect inspection device according to claim 16, wherein
the pupil division mechanism switches between division in the zenith angle direction and division in the azimuth direction, depending on the inspection target or the inspection conditions.

19. The defect inspection device according to claim 16, wherein
the pupil division mechanism includes a linear motion mechanism and a knife edge driven by the linear motion mechanism, and
a cutting edge of the knife edge is disposed to be positioned on a pupil plane of a condenser lens of the detection unit, and the linear motion mechanism moves the cutting edge of the knife edge parallel to the pupil plane.

20. The defect inspection device according to claim 19, wherein
the pupil division mechanism divides the pupil in a zenith angle direction, and
the knife edge has a curved cutting edge shape to reduce a change in pupil allocation in the zenith angle direction due to an azimuth.

21. The defect inspection device according to claim 16, wherein
the pupil division mechanism has a knife edge whose cutting edge shape is a wavy pattern, and
the cutting edge of the knife edge is disposed to be located on the pupil plane of the condenser lens of the detection unit.

22. The defect inspection device according to claim 16, wherein
the pupil division mechanism includes a linear motion mechanism, a rotation mechanism, and a knife edge driven by the linear motion mechanism or the rotation mechanism,
a rotation axis of the rotation mechanism is perpendicular to a plane of the knife edge, and
a direction in which the linear motion mechanism drives the knife edge is a direction that is not perpendicular to either the zenith angle direction or the azimuth direction, and is parallel to a pupil plane of the condenser lens of the detection unit.

23. The defect inspection device according to claim 16, wherein
the pupil division mechanism is a digital mirror device disposed at a position of the pupil plane of the condenser lens of the detection unit, perpendicular to the optical axis of the detection unit.

24. The defect inspection device according to claim 16, wherein
polarization of the scattered light detected by the detection unit is optimized according to the pupil allocation by the pupil division mechanism.

25. The defect inspection device according to claim 16, wherein
the pupil division mechanism adjusts the pupil allocation according to polarization of the illumination light with which the illumination unit irradiates the sample, and optimizes polarization of the scattered light detected by the detection unit according to the polarization of the illumination light and the adjusted pupil allocation by the pupil division mechanism.

26. The defect inspection device according to claim 16, wherein
the signal processing unit optimizes the weighting coefficient when performing weighted addition of the signal from the first photoelectric conversion unit and the signal from the second photoelectric conversion unit, according to the pupil allocation by the pupil division mechanism.

27. The defect inspection device according to claim 16, wherein
the sample is a semiconductor wafer, and
the pupil is divided to have different pupil allocations depending on whether the sample is a semiconductor wafer with a protective film formed to cover a surface of the semiconductor wafer or a semiconductor wafer without the protective film.

28. The defect inspection device according to claim 16, wherein
the pupil division mechanism divides the pupil to have a pupil allocation according to a defect type to be detected from the sample.

29. The defect inspection device according to claim 16, wherein
the pupil division mechanism divides the pupil such that the pupil allocation corresponds to an incidence angle of the illumination light on the sample.

30. An optical system of the detection unit in the defect inspection device according to claim 16, comprising:
a condensing optical system that includes an objective lens and collects scattered light from the sample;
a branching optical member that is disposed on a pupil plane of the objective lens, and branches the scattered light from the condensing optical system into first scattered light and second scattered light;
a first imaging optical system that images the first scattered light on the first photoelectric conversion unit; and
a second imaging optical system that images the second scattered light on the second photoelectric conversion unit, wherein
the first scattered light is scattered light from the sample whose scattering direction is at a predetermined angle or less with respect to a normal direction of the sample, and the second scattered light is scattered light from the sample whose scattering direction is at the predetermined angle or more with respect to the normal direction of the sample, and
the predetermined angle is determined by a position of the branching optical element driven by the pupil division mechanism.
